(19) United States
(12) Patent Application Publication
(10) Pub. No.: US 2004/0015275 A1
(43) Pub. Date: Jan. 22, 2004

(54) Automatic control system for trains

(76) Inventors: Stanley M. Herzog, St. Joseph, MO (US); Ivan E. Bounds, Lake Havasu City, AZ (US); Patrick Harris, Lenexa, KS (US)

Correspondence Address: SHOOK, HARDY & BACON, 1200 MAIN STREET, ONE KANSAS CITY PLACE, KANSAS CITY,, MO, 64105-2118, US

(21) Appl. No.: 10/197,995

(22) Filed: Jul. 18, 2002

(51) Int. Cl. G06F 17/00

(52) U.S. Cl. 701/19; 246/187 R

(57) ABSTRACT

A GPS based system for automatically controlling the travel and other operational functions of a train. The system stores data characteristic of each location long the track such as speed limits, rail crossing locations and station locations. GPS input data provide information as to the current geographic coordinates of the train. If action is necessary such as slowing to conform with speed limits, sounding the horn as a crossing is approached, or announcing the approach to a train station, the system automatically takes the indicated action. Each train transmits its current location to other trains in the vicinity via satellite. An override allows a human operation to intervene and operate the train if necessary.

### FIELD OF THE INVENTION

This invention relates in general to vehicular travel and more particularly to a method and apparatus for automatically controlling the operation of trains using GPS technology.

### BACKGROUND OF THE INVENTION

Global positioning systems (GPS) technology can be used to provide the geographic location of a GPS receiver. The GPS system includes satellites which travel in known orbits and transmit signals that can be picked up by a GPS receiver on the earth. The signal information is processed by the receiver to determine its location using standard triangulation techniques. More recently, the accuracy of the position has been enhanced through the use of differential GPS techniques that can determine the geographic coordinates within about plus or minus one meter.

Various objects have been equipped with GPS receivers, including vehicles such as cars, boats, planes and trains. However, the GPS system has been used primarily to provide only the location of the vehicle and information regarding nearby facilities, as well as route information. The speed, direction and other aspects of the operation of trains have not been effectively controlled using GPS technology, despite its widespread availability and the accuracy with which it can determine geographic locations.

### SUMMARY OF THE INVENTION

It is the principal goal of the invention to make use of GPS technology in a way to automatically control the many operational aspects of train movements.

In accordance with a preferred embodiment of the invention, GPS location data are used to provide the geographic coordinates of the train as it travels along rails. The location is used to automatically control various aspects of the train operation. For example, data as to speed limits at various locations along the track are stored, along with other information such as the locations of rail crossings, rail signals, and railway stations. An onboard computer or other processor continuously checks to see if the train speed is in conformity with the speed limit for the location that is detected by the GPS system. If the train is traveling above the speed limit, the train brakes are applied automatically until the train has slowed to the speed limit. Conversely, the throttle setting is increased automatically if the train is traveling slower than the applicable speed limit.

These and other control operations are programmed into the system so that the action that is taken is automatic and requires no human intervention. When a crossing is being approached, the horn of the train is sounded automatically to warn of its approach. Similarly, when the train is approaching a station, an audible announcement is provided identifying the station that is being approached so that passengers can prepare to exit the train.

The system also receives data informing each train of the location of other trains in the vicinity, all determined using GPS technology. It is preferable that the system have an override feature that allows a human operator to takeover control when necessary. For example, if the operator sees that another train is too close or that a red light is ahead, he can intervene and take corrective action that overrides the automatic control system.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings which form a part of the specification and are to be read in conjunction therewith and in which like reference numerals are used to indicate like parts in the various views:

FIG. 1 is a diagrammatic view of a train that is equipped with a GPS based automatic control system in accordance with a preferred embodiment of the present invention; and;

FIG. 2 is a block diagram showing the functional aspects of the control system constructed in accordance with a preferred embodiment of the invention.

### DETAILED DESCRIPTION OF THE INVENTION

Referring now to the drawings in more detail, numeral 10 generally designates a train that may be equipped with a GPS based control system in accordance with the present invention. The train 10 may be a passenger train, a freight train or another type of train that is propelled along railroad tracks 12.

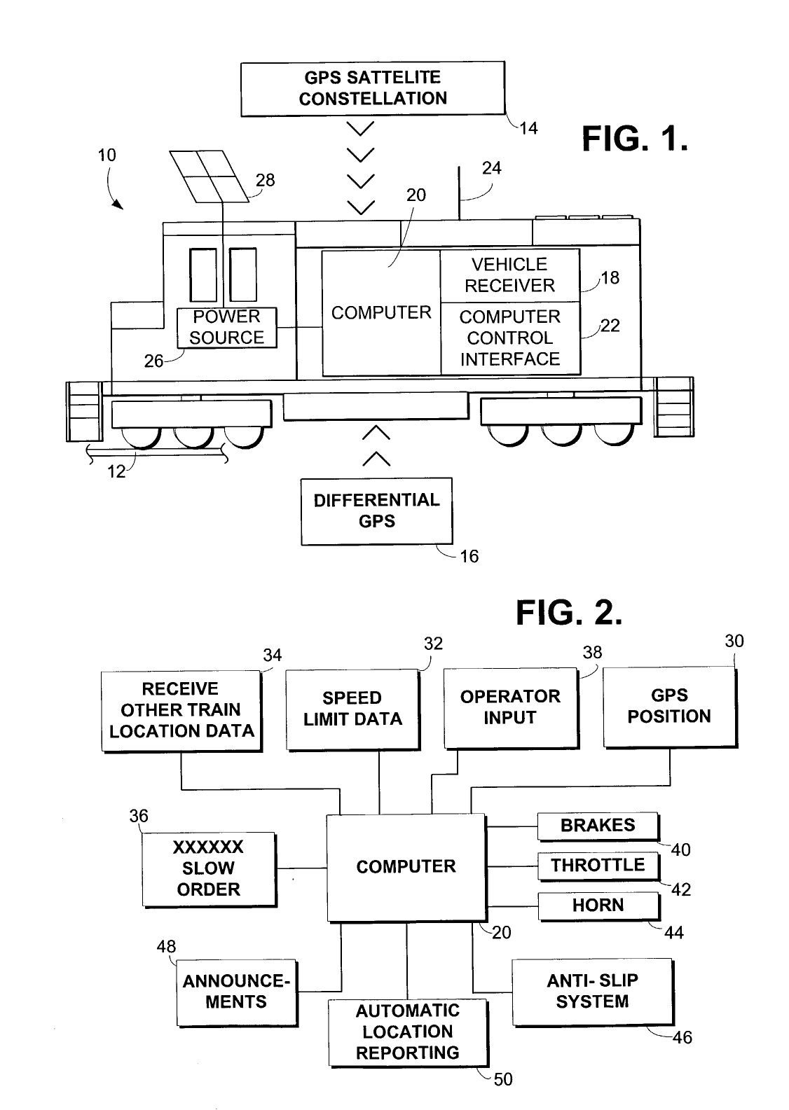

The control system of the present invention makes use of a satellite-based global positioning system (GPS) which is identified by numeral 14 in FIG. 1. The GPS system 14 includes a satellite constellation that includes individual satellites that travel in known orbits. The satellites each transmit signals that are detected by ground-based receivers 18 on board trains. The receiver 18 processing of an array of the visible satellites' signals allows for computation of position in three dimensional space. With the addition of a correction signal, termed differential correction, the position accuracy is enhanced to the extent that this position information now is accurate in the range of ±1 meter. This signal is received by an on-board antenna 19. The train 10 is also equipped with an on-board computer 20 which may be of any type of processing unit that receives the position data from the receiver 18 through the interface system 22. Another antenna 24 on the train transmits to and receives signals from off-board transmitters and receivers in the vicinity to provide the computer 20 with information which verifies, the position of the train 10 as well as providing information relating to the wayside, including the location of other trains in the vicinity. The location of other trains can be detected in this manner or by signals from the other trains transmittal to the antenna 24, or, more preferably, by signals from the satellite constellation giving the locations of other trains in the vicinity.

The train 10 has an on-board electrical power source 26 for operating the receiver 18, computer 20 and other components. The power source 26 may be a rechargeable source that makes use of a solar panel 28 for charging of the power source 26 or providing supplementary power. Alternatively, the power source 26 may take the form of a conventional charging bus of the type commonly found on conventional trains.

Referring now to FIG. 2 in particular, the GPS position 30 is provided by the receiver 18 to computer 20 to provide the computer with data as to the instantaneous geographic coordinates of the train 10. The computer also receives and stores speed limit data 32 which includes information as to the applicable speed limits at each location along the track 12. Another input to the computer 20 is the location of other nearby trains 34, which data is transmitted to the antenna 24 and input to the computer 20 for comparison of the other train locations with the location of train 10. An enter slow order block 34 may provide additional information to the computer 20 telling the computer to initiate slowing of the train when a location such as a crossing or town is being approached. An operator input block indicated at 38 allows a human operator to intervene and override all aspects of the automatic control system. When the operator intervenes at block 38, he can override the automatic control system and operate the brakes 40, throttle 42, horn 44, anti-slip system 46 and/or other operational aspects of the train 10.

In the automatic control mode of operation, the computer 20 provides signals for operating the brakes 40, the throttle 42, the horn 44 and the anti-slip system 46 when the GPS coordinates indicate that one or more of these systems should be activated. Announcements stored in block 48 can be initiated by the computer 20 as indicated by the GPS coordinates. For example, when the GPS data indicate that a particular station or location is being approached by the train 10, a stored audible announcement in block 48 can be initiated to provide an audible message identifying the station that is being approached so that passengers can prepare to exit the train when it stops there. The instantaneous GPS coordinates of the train 10 are reported at block 50 under the control of the computer 20. Data identifying the current geographic coordinates of train 10 are transmitted by the antenna 24 so that other trains in the vicinity and other facilities are provided with the train location.

In operation, the train 10 is controlled in various aspects of its operation by the GPS coordinates as determined by the GPS system 14 and the receiver 18. For example, when the GPS coordinates indicate that the train is traveling on open track with no crossing or towns in the vicinity and a relatively high speed limit, the computer sets the throttle 42 at a position to propel the train at a relatively high speed. When the train enters an area of a reduced speed limit, the GPS coordinates that are sensed by the system and compared with the speed limit data stored in block 32 indicate that the train speed should be reduced to comply with the applicable speed limit. The computer 20 then activates the brakes 40 to slow the train 10 until it is within the speed limit.

Similarly, when the GPS coordinates that are detected indicate that a rail crossing is being approached, the computer 20 can operate the horn and/or bell 44 to provide an audible warning of the approach of the train to the crossing area. A slow order is entered at block 36 when the train approaches an area such as a crossing or town where it is required to reduce its speed. The computer 20 receives the slow order from block 36 and activates the brakes 40 to slow the train to the necessary speed. The anti-slip system 46 is similarly activated automatically when the train 10 approaches a location at which the anti-slip system should be applied during all acceleration and deceleration conditions and all weather conditions.

When the GPS coordinates indicate that a station is being approached, the computer 20 initiates an announcement in block 48 which provides an audible message that identifies the station that is being approached, thereby alerting passengers that they should prepare to exit the train when it stops at the next station.

In this way, the system stores various types of data that reflect conditions which are characteristic of each different geographic location along which the train 10 travels. By detecting the current geographic coordinates of the train using the GPS system, the control system can determine at each location whether action is necessary for the vehicle to conform with the speed limit or other condition that is characteristic of the current train location. At the same time, the override provided by the operator input block 38 allows human intervention at any time by a human operator. For example, if another train is dangerously close to the train 10, the operator can intervene and apply the brakes 40 or throttle 42 as necessary, and he can also sound the horn 44 or take whatever other corrective action may be warranted. Likewise, if a red railway signal is being approached by the train, the operator can intervene and apply the brakes 42 and stop the train. Thus, it is an optional feature of the invention that all trains may be provided with GPS information as to the locations of other nearby trains so that the other train locations can be monitored, both automatically and by the operator, in order to avoid collisions and other dangerous situations.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A method of controlling the operation of a train that travels on a rail traversing different geographic locations, comprising the steps of:
(a) storing data reflecting conditions that are characteristic of said different geographic locations;
(b) detecting the current geographic coordinates of the vehicle as the train travels on said path using a satellite based global positioning system;
(c) using said stored data and the current geographic coordinates of the train to determine for each said geographic location if action is necessary for the train to conform with the conditions that are characteristic of the location corresponding to the current geographic coordinates of the train; and
(d) if determined by step (c) that action is necessary, taking action to conform the train with conditions that are characteristic of each said location.

2. A method as set forth in claim 1, including the step of intervention by a human operator to effect action adjusting the train as commanded by said intervention.

3. A method as set forth in claim 1, including the steps of:
receiving position data reflecting the current position of another train traveling in the vicinity of said path; and
storing said position data as part of the stored data reflecting conditions that are characteristic of said different geographic locations.

4. A method as set forth in claim 3, including the step of providing notification of said current geographic coordinates of said train to said another train.

5. A method as set forth in claim 1, including the step of providing notification of said current geographic coordinates to another train traveling in the vicinity of said path.

6. A method as set forth in claim 1, wherein:
step (a) includes storing data reflecting train speed requirements for each of said locations; and
step (d) includes adjusting the speed of said vehicle at each of said locations if necessary to comply with said speed requirements.

7. A method as set forth in claim 6, wherein step (d) includes:
applying brakes of said train to reduce the train speed into conformity with said train speed requirements if necessary; and
increasing a throttle setting of said train to increase the train speed into conformity with said train speed requirements if necessary.

8. A method as set forth in claim 6, wherein:
step (a) includes storing data reflecting the presence or absence of a crossing of said path at each of said locations; and
step (d) includes activating an audible signal from the train when each location at which a crossing is present is being approached.

9. A method as set forth in claim 1, wherein:
step (a) includes storing data reflecting the presence or absence of a crossing of said path at each of said locations; and
step (d) includes activating an audible signal from the train when each location at which a crossing is present is being approached.

10. A method as set forth in claim 8, wherein:
step (a) includes storing data reflecting for each of said locations whether generation of a message is applicable; and
step (d) includes generating a message from the train for each of said locations at which generation of a message is applicable.

11. A method as set forth in claim 9, wherein:
step (a) includes storing data reflecting for each of said locations whether generation of a message is applicable; and
step (d) includes generating a message from the train for each of said locations at which generation of a message is applicable.

12. A method as set forth in claim 6, wherein:
step (a) includes storing data reflecting for each of said locations whether generation of a message is applicable; and
step (d) includes generating a message from the train for each of said locations at which generation of a message is applicable.

13. A method as set forth in claim 1, wherein:
step (a) includes storing data reflecting for each of said locations whether generation of a message is applicable; and
step (d) includes generating a message from the train for each of said locations at which generation of a message is applicable.

14. A method of controlling the operation of a train traveling along a track, said method comprising the steps of:
(a) storing data reflecting conditions that are characteristic of different geographic locations along said track;
(b) using a satellite based global positioning system to detect the current position of the train along said track;
(c) using said data and the current position of the train to determine if the train is in conformity at each of said locations with the conditions characteristic thereof; and
(d) making an adjustment of the train if necessary to bring it into conformity with the conditions characteristics of each of said locations.

15. A method as set forth in claim 14, including the step of providing for human intervention by an operation to adjust the train as commanded by the operator.

16. A method as set forth in claim 14, wherein:
step (a) includes storing data reflecting a speed limit at each of said locations; and
step (d) includes adjusting the speed of the train at each of said locations if necessary to comply with said speed limit.

17. Apparatus for controlling the operation of a train traveling among different geographic locations, said apparatus comprising:
means for storing data reflecting conditions that are characteristic of each of said locations;
a receiver for receiving signals from a satellite based global positioning system indicative of the current geographic coordinates of the train; and
a control system responsive to the current geographic coordinates of the train and said data to effect conformity of the train with conditions that are characteristic of each location corresponding to the current geographic coordinates of the train.

18. Apparatus as set forth in claim 17, wherein said control system is arranged to permit human intervention for control of the train.

19. Apparatus as set forth in claim 17, including means for receiving data reflecting the location of another train traveling in the vicinity of said locations.

20. Apparatus as set forth in claim 17, including means for notifying other train of the current geographic coordinates of said train.
